(19) United States
(12) Patent Application Publication
(10) Pub. No.: US 2017/0278548 A1
(43) Pub. Date: Sep. 28, 2017

(54) Method and Process for the Production of a Scrapbook Motion Album

(71) Applicant: Janice Sue Lorigan, South Pasadena, CA (US)

(72) Inventor: Janice Sue Lorigan, South Pasadena, CA (US)

(21) Appl. No.: 15/079,937

(22) Filed: Mar. 24, 2016

(51) Int. Cl. G11B 27/036; H04N 9/82

(52) U.S. Cl. CPC G11B 27/036; H04N 9/8211

(57) ABSTRACT

A method and multi-step Process in which planning, organizational skills, recording techniques, and manual manipulations are combined with the operation of digital equipment to produce a single medium that includes silent, still images and one or more videos embedded within. To produce a digital scrapbook, still, silent images are placed around each included video. The produced scrapbook is a digital album that exhibits contrasts, visually and aurally, and, as a result of lingering and counting techniques used during processing, maintains the archival properties of a paper scrapbook with the exception of the videos that produce sound and the illusion of motion.

### PREAMBLE

The Petitioner whose name appears on the following documents respectfully requests that a Patent be granted to such Petitioner for the new and original invention set forth in the specification. The method of selecting, arranging, and recording still images of photos and other paper memorabilia followed by the insertion of representations of one or more digital video segments creates and album of contrasts with a final form that includes a preponderance of still and silent materials and one or more digital segments with sound and the illusion of motion.

### CROSS-REFERENCE TO RELATED APPLICATION

Not applicable

### FEDERALLY-SPONSORED RESEARCH

Not applicable

### BACKGROUND

### Field of Invention

This invention relates to the components of traditional paper scrapbooks such as photos, programs, newspaper articles, tickets, and other memorabilia and to digital video recordings, providing sound and the illusion of motion.

### Background of the Invention

The inventor's interest in dance performances, choreography, and choreographers combined to pave the way for the subject invention. Many performances of various types of dance have been recorded over many years. Choreography, style, patterns and timing of steps, and artistic expression have been captured and preserved by digital recordings, or, during earlier times, by filming.

In time, specific details about the choreographers, rehearsals, dancers, and rankings in competitions became lost. Occasionally, notes on the back of photos, or printed information on a performance program, or annotation in a scrapbook would contribute pertinent data.

The present invention is a method of preserving a richer and more thorough account of dance performances and the details of the background and elements leading to the dance. This new type of album is based on the concept of a traditional scrapbook album. The present invention relates to the still, silent components of a paper scrapbook album interspersed with one or more digital videos or portions of videos each of which provides sound and the illusion of motion, the whole of which creates an album of contrasts. Traditional organizational techniques, maintaining a greater number of still images to the number of video segments, controlling sound level, and using lingering as a recording technique are used to produce a digital album that resembles a paper scrapbook.

### Description of Prior Art and Current Art

A scrapbook is a type of visual album that has endured for more than two centuries. Prior to the invention of photography, scrapbooks contained notes, letters, sketches, and a variety of other types of memorabilia. Currently, many scrapbooks contain photos along with other still images of paper memorabilia. Some scrapbooks are embellished with annotation, decorated pages, and added designs.

Scrapbook ownership is a popular way of preserving personal history and memories, often used to record special occasions and materials related to life milestones. Important records and photos of someone receiving an award are often included.

People in various countries collect photos and memorabilia and place them in paper scrapbooks or albums. The digital age has provided some computer-application programs that allow the user to create digital scrapbooks that include still photos, memorabilia, annotation, and embellishments.

Current art, with limited relationship to the current invention, includes books and scrapbooks that include printed, still materials and photos or pictures that are also still. These books and albums may include a pocket envelope, which houses a DVD. Playing the DVD gives the reader the experience of sound and movement, but the two mediums are separate, not integrated or blended; one still book with print and one DVD. The present invention combines all components and fixes the total sequence onto or into one single medium.

Scrapbook ownership is a popular way of preserving history and memories, often used to record special occasions and personal achievements. Important records and photos of someone receiving a trophy or an award are often included. Scrapbooks can be archival, enduring, and personal.

A type of visual album was patented in 2004, (US-2005/0205515 A1), in which text and video segments were paired together and separated as pairs by blank pages, cushions of time, or digital fading, the whole of which created a timeline slide presentation. The inventor claimed a pattern of pairing video with text, sequencing each pair, and separating the pairs with blank pages or fading techniques.

The present invention is a digital facsimile of a paper scrapbook album. The process used for this scrapbook production adheres to a rigid procedure regarding patterns and proportions of still images to video. Recording the sequence of the present invention requires no blank spaces or cushions of time or fading techniques. Any blank spaces or cushions of time have occurred accidentally during recording and would be minimal. Rather than blank pages, the segments of the scrapbook album are placed side by side. The foundation of the present invention is composed of many still images of photos or memorabilia (with or without text). The present invention requires sound and motion, exclusively in the video segments. Each representation of an image relays stillness and quietness.

Prior art includes inventions based upon digital videos or segments of digital videos, but those inventions differ from the present invention in that their compositions are dominated by videos (or at least contain less still materials or text pages than the amount of video segments). A video that is not set and fixed onto one single medium is probably not an album.

Certain activities cannot be adequately portrayed with notes, articles, and still photos. Choreographed motion is one of those activities. For example, one can write about and take twenty photos of a tap dance routine, but viewing the collection of photos and reading written descriptions can only give a limited representation. The pace of the movement, coordination and energy of the dance, and the overall effect of the choreography are missing from the experience. Still photography cannot sufficiently represent and display activities such as dancing, figure skating competition, and gymnastic floor routines. These high-energy, choreographed routines require digital recording to generate true-to-life representation. Digital systems more fully relay the illusion of motion, and it also enhance the viewing experience.

### ADVANTAGES OF INVENTION

(a) To provide visual enhancement and true-to-life representations of high motion activities or choreography

(b) To make a permanent record of choreography and provide other background or detailed information in one place on a single medium

(c) To provide a feeling of pride of album ownership for an album that has captured the illusion of motion

(d) To provide richness, variety, and contrast between sound and silence and movement and stillness

(e) To provide reliability and stability, to the overall final album, and add dynamism, change, and the illusion of motion to specific components

(f) To help memorialize events that are centered primarily around choreography or around fast highly-active movements

(g) To place moments of stability, quietness, and stillness in juxtaposition with moments of movement, expressiveness, depth, and sound

(h) To permanently fix materials, some of which were originally without digital enhancement and some other materials, powered by digital technology, onto one single medium, creating a reliable visual album

Thus, the reach and scope of the invention is determined by the claim and its legal equivalents, not be the illustrations or examples given or by the equipment or devices used.

### OBJECTIVE OF THE INVENTION

The objective of the present invention is to create an album that is overall similar to a scrapbook album, especially in its properties of variety, stillness, quietness, and permanence. Because the addition of one or more video segments will add greater force, and sound, and the illusion of motion, the number and length of video segments must be considered. The number of still images must be significantly greater than the number of videos to counter-balance the strength and impact of the videos and to guard against overpowering the basic album character of peacefulness, history, permanence and stillness. The album is enriched and expanded with additions of video segments. The video segments provide contrast with the still segments and are needed to portray true-to-life and fuller representations of movement and choreography. The juxtaposition of still silent images with videos creates an album that is greater than the sum of its parts.

The following is a fictional story provided for the purpose of illustration.

### “Trudy Lee's Dance History and Performances”

Trudy Lee has excelled in dance for several years. Her mother, Mrs. Lee, has saved dance memorabilia and arranged and positioned them in a scrapbook. Additionally, Mrs. Lee has used a digital recording device to record and keep portions of her daughter's performances in the annual recital. Those recordings are stored in digital memory.

Mrs. Lee places great value on her collection and intends for her collection of photos, still materials, and video segments to be used for future viewing to preserve memories and to make a visual record of Trudy's talent and progress. Trudy is interested in keeping true-to-life representations of the steps of the dance choreography.

Mrs. Lee takes stock of available equipment and plans to select her favorite photos and special items and to plan a strategy that will combine all of her selections into one solid album. She realizes she will have to make notes of items, plan a sequence, and give careful attention to the details of her strategy. In preparation, she collects a USB cable, charges up her digital recording device, and plans a recording time in which she can concentrate and record in an area in which she can control sound levels and silence extraneous sources of noise. She will use two electronic screens, or lap top screens, a DVD player, a converter to DVD device, and the digital recording device that already contains in memory the recordings of Trudy's two dance recitals. Mrs. Lee will need several blank digital video discs (DVDs). Prior to starting the process, she quickly composes a brief list of her selections.

Mrs. Lee wants to include two video segments of separate parts of two different annual recital performances. Each recorded routine is a little over a minute and a half in length. She arranges and identifies her selected items and makes a list of the sequence of her still images and videos. Most of the list is in chronological order. She numbers each still image and assigns a capital letter to each video segment.

### Mrs. Lee's List of Order of Still Images and Videos

1. Printed Cover Page “Trudy Lee's Dance Years”

2. Group Photo of Trudy's 2014 Tap Class

3. Photo of Trudy with friends standing with the teacher

4. Photo of the rehearsal room at the dance studio

5. Picture and text on the front of one of the performance programs

6. Photo of Trudy in a performance costume

X Video of Trudy's part in the 2014 Dance Recital

7. Photo of Trudy standing with other dancers

8. Photo of Trudy putting on her tap shoes

W Video of Trudy's part in the 2016 Dance Recital

9. Photo of Trudy and others on Stage taking bows

10. Photo of Trudy receiving roses on stage

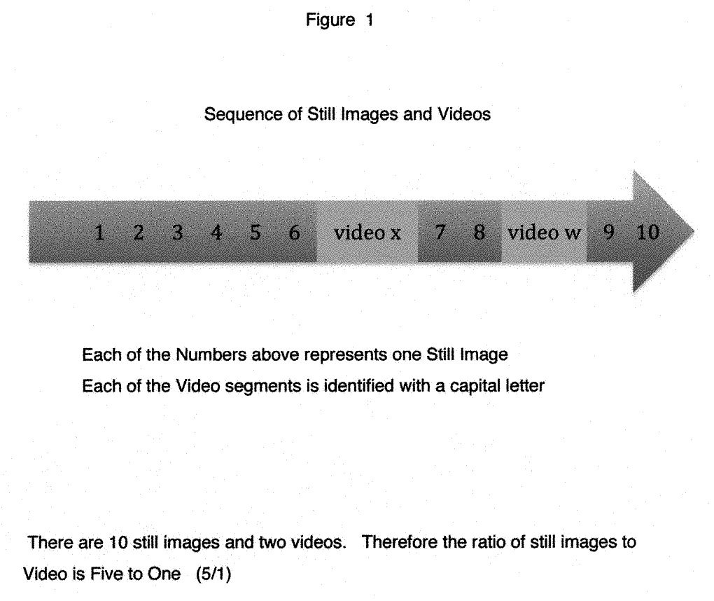

Mrs. Lee finalizes her list and keeps it for reference. She has ten (10) still images and two (2) video segments. The contents of her album will be 10 still images and 2 videos creating a ratio of five to one (5/1); 5 still images for each video. Each video will be preceded by one or more still images. (See FIG. 1)

In order to produce and maintain the resemblance of the final album to a traditional scrapbook, selection, placement, and the ratio of still images to videos or video segments are important considerations. The beginning of the sequence should contain one or more still images; each video segment should be adjacent to and preceded by one or more still images; and the end of the entire sequence must have one or more still images. Therefore, during the planning stage and throughout the process, the selection of materials should adhere to a formula of not less than four (4) still images for every one (1) video segment (4/1). A preferable ratio would have a great number of images for each selected video. (In the case of Mrs. Lee's project, the ratio is five to one (5/1.)

There are numerous ways to achieve the same end. However, Mrs. Lee has access to equipment that limits her choice of method. She chooses a method that has many steps. However, her selected method facilitates finding, arranging, and recording all the separate parts and can help to achieve greater accuracy than some other methods. Mrs. Lee will end up using six (6) or more new blank DVDs, approximately.

### PROCESS AND METHOD

### Planning and Preparation

1. Select and collect still images, such as photos, newspaper article programs, memorabilia, etc.

2. Write down order of sequence of still images.

3. Locate desired videos in digital memory and make note of each start point on digital recoding.

4. Write down sequence of selected items;
a. The first still image can be a Title page, but any still image is appropriate.
b. Determine order of other still entries.
c. Just prior to each video segment place one or more still images.
d. Make sure the ratio of still images to videos is at least four to one (4/1).
e. End the entire sequence with one or more still images (not with video).

### Collection and Sequencing of Still Images and Videos

5. Fasten all 10 still images to one separate paper each, each paper being the same size as all the others.

6. In order of sequence, one after another, in a row, attach or fasten each page with each still image on a wall or large board or stable surface. In accordance with the example of the fictional story, slightly wider spaces are needed in two places only on the wall; one space between the photo of Trudy in her costume (image #6) and the photo of Trudy standing with other dancers (image #7) and a second space between the images of the photo of Trudy putting on her tap shoes (image #8) and the photo of Trudy and others taking bows (image #9). Arranging slightly wider spaces between still images posted on the wall or board is simply a recording technique tool for the first digital recording of still images. The spaces are a visual reminder of the end of a section. The final digital recording of the entire sequence avoids creating any spaces.

7. Make the environment as quiet as possible by muting devices, turning off broadcasts, etc. (If using software program “mute” or disallow the sound)

### Production of DVD I

8. Holding digital recorder device as steady as possible, begin recording in a soundless or muted environment. With steady hands, or using the help of a secure pedestal, record the first still image (in the Trudy Lee example, the Title Page) maintaining the focus of the camera for a longer than normal time (linger). Count slowly, and without any vocalizations, slowly one (1) to ten (10). After counting, stop recording gently and without jerking the device to avoid picking up any illusions of motion.

9. Move to the second still image. Again record with steady hands and again with counting slowly to ten. Linger by slow counting while recording each still image keeping the digital device steady. After counting, stop recording and reposition in front of the next still image.

10. Move to the 3rd still image. Again, record with steady hands and count slowly to ten. Stop without jerking the digital recording device.

11. Move the 4th still image. Again with steady hands and counting slowly to ten and stopping without jerking the equipment.

12. Move to the 5th still page (in this case, image of cover of front of dance performance program). Again hold the equipment with steady hands, count slowly to twelve, and stop without jerking or moving the equipment until after stopping the recording. (Since there is text on the front of the program, more counting time will provide future viewers with more time to read.)

13. Move to the proper distance in front of the 6th image and repeat recording and count slowly to ten (10), as above. Stop recording.

14. Connect the Converter to DVD device to a television or computerized system with a screen. Attach the digital recording device to the Converter to DVD device.

15. Make sure the connections between equipment and devices are secure and turn on all.

16. Select correct “input” to connect the Converter to DVD device with the screen.

17. Insert a new blank DVD into the receptacle or tray of the Converter to DVD device

18. Use the remote of the Converter to DVD device or the device itself to affect the functions of play, copy, and dub to transfer from memory the new digital recordings of the still images to the Converter to DVD system.

19. When the screen indicates 100% completion, confirm the finalization step to permanently fix the recording of the still images to the DVD. Eject the DVD. Label or mark the first created DVD, thusly, DVD I (Roman Numeral I). Put the DVD aside for use later.

### Production of DVD III

(* Note. Roman Numeral I followed by Roman Numeral III may seem out of place, but this is done to keep track of organization and planned sequencing.)

20. Return to the board or wall with the posted still images. The two photos in need of recording are Numbers 7 and 8 on Mrs. Lee's list; one photo of Trudy standing with other dancers and one photo of Trudy putting on tap shoes.

21. Fix the focus of the digital recording device the photo of Trudy standing with other dancers. Hold the device very steadily or use the aid of a sturdy pedestal. Maintain a quiet environment. Record the photo while counting slowly, in your head, not making noise, 1 . . . 2 . . . etc. . . . up to 10. After the count of ten, gently, without jerking the equipment, stop recording.

22. Repeat the process described in Number 21 above while positioned in front of the photo of Trudy putting on her tap shoes. Stop recording.

23. Return to the Converter to DVD device and connected screen and reconnect the digital recording device to the Converter. Once the connections are secure and the correct “Input” has been established, insert another blank DVD into the Converter. Follow Steps 18 and 19 above, except after the finalization step, eject the DVD and mark or label the new DVD thusly, DVD III. Set this DVD aside for later use.

### Production of DVD V

24. Return to the board or wall with the posted still images. Take a position in front of the photo of Trudy and others taking a bow on stage. Follow the same instructions as Numbers 20 through 23 above, except now record #9 and #10 on Mrs. Lee's list (still images #9 and 10). First record the still image of Trudy taking a bow and then the image of photo of Trudy receiving roses. After confirming the finalization of the new DVD, eject the new DVD and mark it thusly, DVD V. Set this DVD aside for later use.

### Production of DVD II

25. Now the two dance performances must be extracted from the memory of the digital recording device and transferred into the memory of the Converter to DVD device. One new DVD will be created for each of the performances. Insert a new blank DVD into the tray or receptacle of the Converter to DVD device. Locate the beginning of the 2014 Dance Recital performance of Trudy. Press Play and Record while following the steps of Numbers 18 and 19 above. (Except, ignore wrong label above.) After finishing and ejecting the DVD, mark the new DVD thusly, DVD II. Set aside for later use.

### Production of DVD IV

26. The second dance performance is of the recital in 2016. Insert a new blank DVD into the Converter to DVD device. Locate the beginning of the 2016 performance with Trudy. Follow the steps of Numbers 18 and 19 above which specifies the functions of Play, Record, Dub, and finalization. After the screen indicates 100% finalization, eject the new DVD and mark it thusly, DVD IV

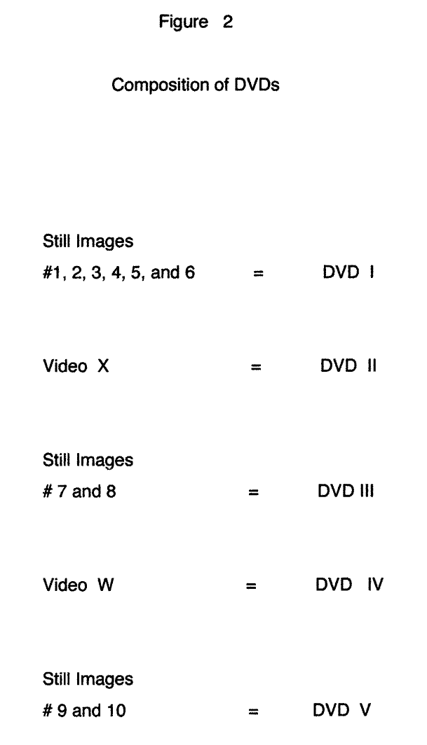

### Recording 5 DVDs in Proper Sequence (FIG. 2)

27. Gather the 5 newly created DVDs (I, II, III, IV, and V). Return to the screen that is synchronized with a DVD player. Turn on systems and select proper input.

28. Experiment until the proper distance of the digital recording device from the screen is calculated. Ideally, the camera will record all of the digital recording being run on the screen, without any extraneous visual materials, such as the materials surrounding the screen. Begin by inserting DVD I and recording while stabilizing the device or holding it with very steady hands.

29. Eject DVD I from the DVD player and insert DVD II. Resume recording until end of DVDII.

30. Eject DVD II and insert DVD III. Resume recording. At end pause or stop.

31. Eject DVD III and insert DVD IV. Resume recoding. Stop at End.

32. Eject DVD IV and insert DVD V. Resume recording until end of DVD V.

33. After completion of the recording of the DVDs, transport the digital recording device holding all the new material in memory, to the Converter to DVD device attached to a screen.

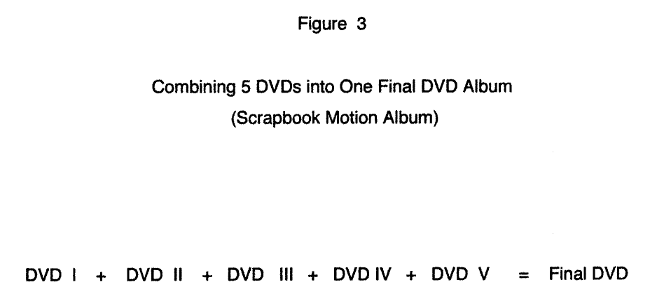

### Transferring the Recorded Sequence of Still Images and Video (FIG. 3)

34. Re-attach the digital recording device to the Converter to DVD device. Secure all connections. Select the appropriate Input.

35. Insert a new Blank DVD into the receptacle of the Converter to DVD device. Using the Converter remote or functions on the digital recording device or Converter, affect the functions of Play, Record, and Dub. When finalization is at 100%, confirm by answering “Yes”, if required by system.

### Labeling the Final, Completed DVD Album

36. Eject the newly created DVD. Label the new, final DVD, thusly “Album of Trudy Lee's Performances and Memorabilia”, (example)

FIGS. 1, 2, and 3 are flow charts illustrating the method used by Mrs. Lee:

FIG. 1 is a representation of the sequence and the number of still images and the number of videos embedded within. FIG. 2 illustrates the process of recording each still image and each video. FIG. 3 represents the process of combining and finalizing the completed sequence onto one medium.

### SECOND ALTERNATE METHOD

Using the same equipment, devices, and organizational techniques. Mrs. Lee can choose an alternative method and process that will bring the same results as the first method discussed and numbered above.

The advantages of this second method is that she will need less blank DVDs for the process, and she will spend less time recording and converting digital memory to DVDs. The disadvantage of this alternative process may present difficulties that will outweigh the benefits of limiting the number of DVDs and shortening recording time.

The disadvantage of this alternative method is that locating the beginning of each desired section and ending recording at the exact preferred moment becomes more difficult than the first method discussed above. Locating the start and stop points with accuracy may bring unwanted challenges.

The second method uses the same procedures of planning, preparation, recording, and counting and lingering as the first method.

1. Follow steps #1 through #13 in the first method detailed above, adhering to the sequencing pattern, environmental controls, equipment manipulation, and proportion considerations. Continue recording all still images at one time, until all 10 still images are recorded and in memory.

2. Follow steps #15 though #19 in the first method discussed above.

3. At end of recording, reconnect the digital recording device to the Converter to DVD device. Make sure connections are solidly attached between recording devices.

4. Converter to DVD device, and the screen of a television or other digital device with a screen. Insert a new blank DVD.

5. Transfer the digital recording of the still images of #1 through #10 using the functions of Play, Record, Dub, and Finalize.

6. After finalization, eject the DVD and label or mark it with words “Still Images”. Set aside

7. Insert a new blank DVD into the receptacle of the Converter to DVD.

8. Select the first dance performance (2014) on the recording device.

9. Continue recording the next digital segment of the 2016 dance recital.

10. Use the functions of Play, Record, Dub, and finalization until 100% complete.

11. Eject the new DVD and mark of or label it with “Dance Performances”

12. Return with the new DVDs to the digital screen and DVD player configuration.

13. Prepare the digital recording device and approximate the distance between the digital recording device and the screen to ensure recording the screen only without recording extraneous materials outside of the screen.

14. Insert the Still Image DVD into the slot of the DVD player. Begin to play, and use digital recording device to record until the end of Still Image #6 (record still images #1 through #6) Turn off or pause the digital recording device.

15. Eject the Still Image DVD. Insert the Dance Performances DVD.

16. Play DVD and record the 2014 dance performance by focusing digital recording device on the screen.

17. Stop recording after the 2014 Dance Performance. Eject the Dance Performance DVD and insert the Still Image Video.

18. Locate Still Images #7 and 8.

19. Once again record with digital recording device from screen until end of still Image #8 (still images #7 and 8). Eject DVD labeled Still Images.

20. Insert DVD labeled Dance Performances. Locate the beginning of the 2016 Dance Recital.

21. Again position the digital recording device, play the 2016 dance recital on the Player while operating the digital recording device to record.

22. At end of Dance Performance DVD, eject the DVD and insert the DVD labeled “Dance Performances.

23. Locate still images #9 and #10 on the DVD.

24. Again reposition, play DVD with images #9 and #10, and record the screen.

25. Record from the screen, holding the camera very steadily and maintaining a very quiet environment, except the sounds accompanying the segments of DVD with motion and sound.

26. End recording and reconnect the digital recording device to the Converter to DVD device.

27. Insert a new blank DVD into the Converter to DVD device. Transfer the digital recording device memory of the combined still images and two dance performances to the Converter to DVD device, using the functions of Play, Record, Dub, and Finalize.

28. At 100% complete, finalize. Eject DVD. And mark it with a title, such as “Trudy Lee's Memorabilia and Performance”. Now, the digital album containing images and photos and with inserted videos, providing the illusion of motion, are all fixed onto one medium.

### THIRD ALTERNATIVE METHOD FOR THE PRODUCTION OF A SCRAPBOOK MOTION ALBUM

The third method requires computer assistance, a scanner, and coding and programming techniques.

1. One at a time, scan each still image into a computerized system.

2. Feed the digital recordings into the same computerized system.

3. Program to record again each still image with slowness (a type of pause)

4. Code and program the computerized system to alternate the re-recorded images and each dance performance, thusly, Images #1 through #6; Dance Performance 2014; Images #7 and #8; Dance Performance 2016; and Images #9 and #10.

5. Incorporate sound in addition to all the visual segments (of course, there is no sound to record for any of the still images. Sound will be a part of the video segments only.)

6. After sequencing, program to create one final digital memory of combined segments.

7. Burn a new DVD containing all of the materials in proper sequence.

8. The newly created DVD is a digital representation of a Scrapbook Motion Album containing still silent images in juxtaposition with segments of video providing the illusion of motion.

### CONCLUSION AND SCOPE

Still photography, still images and news articles cannot replicate the illusion of motion with as much depth, completeness and realism as that relayed by digital technology. The present invention captures the dynamism, sound, and true-to-life aspects of the illusion of motion and places segments of that illusion in juxtaposition with the still, quiet, and peaceful aspects of still images of traditional albums. The present invention is an album of contrasts, and the overall character of the album is based on the attributes of a typical traditional paper scrapbook album. Including a great number of still images to the number of video segments and beginning and ending the sequence with one or more still images, all combine to further ensure the overall character of a scrapbook album.

Accordingly, the process of selecting still photos and memorabilia, recording them digitally, allowing for lengthy time for recording each still image (lingering), and holding the digital recording device steady, in a controlled quiet environment serves to replicate the stillness and quietness of the viewing experience of that of a scrapbook album. The silence and motionlessness of the scrapbook materials provide contrast and emphasis for the inserted digital segments of movement and motion. In turn, the digital segments provide sound, depth, and the illusion of motion, which contrast with the still segments.

Although the descriptions in the specification contain examples and illustrations, neither the examples nor the illustrations should be considered as limitations to the invention, but as merely providing examples for clarity. Additionally, the software, hardware, devices, digital machines, converters, and electronic equipment used, or referred to, do not affect the claim of this patent.

Thus, the scope of the invention should be determined by the claim and the legal equivalent of the claim, and not by illustrations, examples, hardware, software, devices, or equipment. The scope of the invention is limited to the claim as specified in the claim.

### SUMMARY

In accordance with the present invention, the new scrapbook motion album merges the sense of stability and the archival attributes of traditional visual albums and scrapbooks with the dynamism, fullness, and true-to-life properties of digital videos. The illusion of motion produced by videos contributes fuller and more detailed representations of dance steps, positions, pace, and movement of choreography. Working together, the acts of planning, sequencing, segment placement, and recording, place still images side by side with motion-filled videos. Placing still, silent images in juxtaposition with videos with sound and the illusion of motion creates a unique album of contrasts. The present invention preserves some positive attributes of traditional paper scrapbooks, including its stillness and quietness. Combining and merging various segments of still materials and segments of videos relaying the illusion of motion help develop a visual album that imitates the character of paper scrapbook albums, but is distinguished also by the insertion of the illusion of motion. One underlying purpose of the proposed invention is to borrow the stable and archival properties of traditional visual albums and place those features in juxtaposition with the illusion of motion, energy, and sound of digital videos. The present invention is a process and method that creates an album of contrasts between the illusion of motion and sounds of video, and the peacefulness, stillness, and quietness of still images.

I claim:

1-12. (canceled)

13. A method and multi-step process for the production of a digital album of recorded, paused, silent still images with one or more video segments, contributing sound and the illusion of motion, embedded within, comprising
a.) preparing for the multi-step process by gathering materials, blank, unused DVDs, and digital equipment, and printing a readable note or outline of the intended sequence of still, silent mages and one or more videos or video segments,
b.) recording still images of paper items or photographs or of both paper items and photographs or of any combination by fixing each still image to a separate, sheet of paper, fastening each sheet of paper consecutively in a row with the other sheets of paper on a board or wall, and capturing each still image separately with a digital recording device while lingering while recording, or while sustaining the focus of the recording device on the image and recording while counting, during the same time as recording, counting silently to oneself for several to many seconds in a silenced or very quiet environment,
c.) transferring the captured still images in the memory of the recording device, first, to the memory of a converter, followed by the transference and conversion of the same still images to separate, blank DVDs, the recorded still images singularly or in pairs or multiples, singular or consecutive still images together placement related to the intended placement around its or their related video segment,
d.) digitally recording each video or each video segment by playing it on a DVD player, viewing the screen and, at the same time, focusing the digital recording device on the screen and operating the device to capture the video playing on the screen while holding steadily the digital recording device in a quiet or silenced environment, allowing for the sounds produced from playing the video or video segments,
e.) transferring each video or video segment, separately, from the memory of the digital recording device into the memory of a digital converter followed by the conversion and transference of each video or video segment onto a separate blank, unused DVD,
f.) gathering all the DVDs, those with recorded still images and those with a recorded video or video segments, and arranging them in order of intended placement, according to the sequence of order as printed on the readable note or outline, the gathered DVDs arranged to provide for easy access by placing the gathered DVDs in dose proximity to the DVD player,
g.) recording again, the contents of all DVDs, still images and one or more video segments, by inserting and ejecting each DVD into and from the DVD player, each in turn, and viewing the DVD contents on the screen while capturing the images displayed on the screen by operating a digital recording device with a steady hand, recording in a quiet room or silenced environment, allowing for the sound produced from the video during the playing and recording of the video or video segments.
h.) transferring from the memory of the digital recording device, the recorded, combined materials of recorded still images and recorded video segments, recorded from the played DVDs into the memory of the digital converter into which has been inserted with a new separate, blank DVD,
i.) transferring the combined sequence of recorded still images and a recorded video or a video segment or video segments by using the function of a digital converter and then finalizing by using the finalization function of the digital converter, and completing the process by downloading or fixing the recorded sequence onto the inserted DVD, the preceding steps of which produce a digital album with both recorded still, silent images and a recorded video segment or video segments contributing sound and the illusion of motion.
Whereas, an arranged, recorded sequence of still, silent images and a video or video segment fixed onto a DVD containing within a greater number of recorded still images than the number of recorded videos or video segments, with the video segment placed among and directly adjacent to still images, combines to create a visual digital album distinguished by both its archival properties and its contrasts, sound and motion, on one hand, and stillness and silence, on the other.
